(19) United States
(12) Patent Application Publication
(10) Pub. No.: US 2009/0160846 A1
(43) Pub. Date: Jun. 25, 2009

(54) DISPLAY DEVICE

(75) Inventor: Steven Charles Deane, Redhill (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/300,642

(22) PCT Filed: May 9, 2007
(86) PCT No.: PCT/IB07/51733

§ 371 Date: Nov. 13, 2008

(30) Foreign Application Priority Data
May 17, 2006 (EP) 06114118.0

(51) Int. Cl. G09G 5/00; G09G 3/28

(52) U.S. Cl. 345/214; 345/60

(57) ABSTRACT

A system for driving a moving particle display device, such as an electrophoretic display device, is disclosed. The display device comprises first and second cells (30) that are set to target optical states to give the cells' their target optical appearances. The first and second cells are driven differently from one another, such that errors in the first cell's target optical state occur in the opposite direction to errors in the second cell's target optical state. Hence, when the cells are viewed from a distance by a viewer of the display, the light from the first and second cells mixes together, and the optical state errors appear to compensate or cancel one another out.

The invention relates to moving particle displays, and in particular to a method of driving such displays.

Previous moving particle displays, such as electrophoretic displays, have been known for many years; for example from U.S. Pat. No. 3,612,758.

The fundamental principle of electrophoretic displays is that the appearance of an electrophoretic material encapsulated in the display is controllable by means of electrical fields.

To this end the electrophoretic material typically comprises electrically charged particles having a first optical appearance (e.g. black) contained in a fluid such as liquid or air having a second optical appearance (e.g. white), different from the first optical appearance. The display typically comprises a plurality of pixels, each pixel being separately controllable by means of separate electric fields supplied by electrode arrangements. The particles are thus movable by means of an electric field between visible positions, invisible positions, and possibly also intermediate semi-visible positions. Thereby the appearance of the display is controllable. The invisible positions of the particles can for example be in the depth of the liquid or behind a black mask.

The distance that a particle moves through electrophoretic material is roughly proportional to the integral of the applied electric field with respect to time. Hence the greater the electric field strength, and the longer the electric field is applied for, the further the particles will move.

A more recent design of an electrophoretic display is described by E Ink Corporation in, for example, WO99/53373.

In-plane electrophoretic displays use electric fields that are lateral to the display substrate to move particles from a masked area hidden from the viewer to a viewing area. The larger the number of particles that are moved to/from the viewing area, the greater the change in the optical appearance of the viewing area. Applicant's International Application WO2004/008238 gives an example of a typical in-plane electrophoretic display.

Typically, the extreme (e.g. black and white) optical states of moving particle displays are well defined, with all particles being attracted to one particular electrode. However, in intermediate optical states (grey levels), there will always be a spatial spread among the particles.

Greyscales or intermediate optical states in electrophoretic displays are generally provided by applying voltage pulses for specified time periods, in order to spatially distribute particles through the electrophoretic material. However, a fundamental problem is that it is very difficult to accurately control and keep track of the actual positions of the particles in the electrophoretic material, and even minor spatial deviations might result in visible greyscale disturbances. Such spatial deviations can easily occur due to errors in the applied voltages, and due to changes in the temperature of the electrophoretic material. Errors in the applied voltages alter the electric field strengths that the particles feel, causing the particles to move further or less far than intended. Changes in the temperature of the electrophoretic material may alter the material's viscosity, thereby altering the speed at which particles move. The speed of particles is an important factor in determining the final particle positions, and hence the display output varies significantly as the temperature of the display changes.

Furthermore, addressing a display with subsequent grey levels causes the grey level errors to accumulate through successive particle positioning errors.

Applicant's International Patent Publication WO 2004/034366 discloses that the grey level accuracy can be improved by using a rail-stabilized approach, which means that the grey levels are always addressed via a well defined reset state, typically one of the extreme states (i.e. rails) where all particles are attracted to one particular electrode. The benefit of this approach is that the extreme states are stable and well defined, as opposed to the less well defined intermediate states. The extreme states are thus used as reference states for each greyscale transition. Therefore, using this method, the uncertainties in each grey level theoretically depend only upon the actual addressing of that particular grey level, since the initial particle position is well known.

However, this form of display still has the fundamental drawback that it is very difficult to accurately control and keep track of the actual positions of the particles in the electrophoretic media, making accurate setting of greyscale or intermediate optical states difficult.

It is therefore an object of the invention to improve upon the known art.

According to a first aspect of the invention, there is provided a method for driving a display device, the display device comprising at least one pair of first and second cells, the first and second cells of the pair being positioned adjacent to one another, each cell comprising:

movable charged particles;

a storage region into which at least some of the charged particles may be moved;

a gate region into which at least some of the charged particles may be moved; and

a display region into which at least some of the charged particles may be moved; the number of charged particles in the display region determining an optical state of the cell; and

the method comprising:

setting the first cell of the pair to a storage mode by electrically attracting the first cell's charged particles to the first cell's storage region;

setting the second cell of the pair to a gate mode by electrically attracting the second cell's charged particles to the second cell's gate region;

setting the first cell from the storage mode to a target optical state by electrically attracting a display number of the first cell's charged particles from the first cell's storage region to the first cell's gate region, and then from the first cell's gate region to the first cell's display region; and

setting the second cell from the gate mode to a target optical state by electrically attracting a surplus number of the second cell's charged particles from the second cell's gate region to the second cell's storage region, leaving a display number of the second cell's charged particles in the second cell's gate region, and then electrically attracting the second cell's display number of particles from the second cell's gate region to the second cell's display region.

As a result of the first aspect, errors in the cell's optical states due to higher or lower numbers of particles moving between storage and gate regions than intended appear to substantially cancel one another out when the cells are viewed by a viewer. This is because the display number of particles is set using one method for the first cell, and using a different method for the second cell. In the first cell, the display number is set by moving particles to the gate region, whereas in the second cell, the display number is set by moving particles away from the gate region. Therefore, if a change common to both cells occurs (e.g. a temperature increase), and this change causes more particles than predicted to move between the storage and gate regions, then the display number of particles of the first cell increases (since more particles are moved to the cell's gate region), and the display number of particles of the second cell decreases (since more particles are moved away from the cell's gate region). Therefore, after each cell's display number of particles are moved to the cell's display region, the first cell's display region will have a larger number of the first cell's particles than intended, and the second cell's display region will have a smaller number of the second cell's particles than intended. When the two cells are viewed from a distance, the light from each of the two cells will merge, and so the user will actually perceive light making the two cells look as though they both had substantially the same display numbers of particles as originally intended. Hence, due to the invention, the optical state errors in the individual cells become much less apparent to a viewer viewing the display, and so the apparent grey level accuracy is greatly improved.

Advantageously, the method steps of the first aspect may be carried out in an ordering whereby the first and second cells are set to their target optical states for overlapping time periods, to enhance the apparent cancellation of optical state errors when the cells are viewed by a viewer.

Additionally, the method steps may be repeated with the first cell driven as though it were the second cell, and the second cell driven as though it were the first cell. Such a reversal of the driving scheme may help to prevent particles from becoming “stuck” in one position, or from unwanted residual voltages building up in the display device structure.

Furthermore, each cell preferably has cell electrodes comprising storage, gate and display electrodes. Each cell's storage, gate, and display electrodes are respectively associated with the cell's storage, gate, and display regions. The storage, gate and display electrodes may be drivable by driver circuitry to set up electric fields in the various regions of each cell, thereby controlling the movement of each cell's charged particles. This arrangement has the advantage that only three cell electrodes (storage, gate, display) are required to drive the cell. A similar arrangement is described in the Applicant's co-pending U.S. Patent Application 60/726,854 (Applicant's reference PH002317).

Alternative cell electrode arrangements may also be used, for example the single display electrode may be replaced with multiple display electrodes for improving the distribution of the particles through the display region, or for improving the speed at which particles move through the display region.

The distances that particles travel typically depends on the integral of the electric field strength with respect to time. Hence, the various cell electrodes are preferably driven to set up certain electric field strengths for certain lengths of time, such that the required numbers of particles are moved between the various regions of the cells.

Advantageously, the display device of the method may comprise multiple pairs of cells arranged in an array of rows and columns. The cells forming even numbered rows may be driven as first cells, and the cells forming odd numbered rows may be driven as second cells. This arrangement may simplify the circuitry required to drive the first and second cells. Alternatively, the cells along each row may alternate between cells that are driven as first or second cells, and the cells along each column may also alternate between cells that are driven as first or second cells, thereby forming an arrangement of first and second cells similar to a checkerboard. The advantage of this arrangement is that each first cell will have four immediately adjacent first cells and four immediately adjacent second cells. Hence the apparent cancellation of optical state errors between first and second cells is enhanced. Other similar ways of arranging the first and second cells within the array will also be apparent to those skilled in the art.

According to a second aspect of the invention, there is provided a display device comprising at least one pair of first and second cells, the first and second cells of the pair being positioned adjacent to one another, each cell comprising:

movable charged particles;

a storage region into which at least some of the charged particles may be moved;

a gate region into which at least some of the charged particles may be moved; and

a display region into which at least some of the charged particles may be moved; the number of charged particles in the display region determining an optical state of the cell; and

the display device further comprising address electrodes and electronic drive circuitry, the drive circuitry being configured to drive the address electrodes so as to:

set the first cell of the pair to a storage mode by electrically attracting the first cell's charged particles to the first cell's storage region;

set the second cell of the pair to a gate mode by electrically attracting the second cell's charged particles to the second cell's gate region;

set the first cell from the storage mode to a target optical state by electrically attracting a display number of the first cell's charged particles from the first cell's storage region to the first cell's gate region, and then from the first cell's gate region to the first cell's display region; and

set the second cell from the gate mode to a target optical state by electrically attracting a surplus number of the second cell's charged particles from the second cell's gate region to the second cell's storage region, leaving a display number of the second cell's charged particles in the second cell's gate region, and then electrically attracting the second cell's display number of particles from the second cell's gate region to the second cell's display region.

As a result of the second aspect, there is provided a display device having cells whose optical state errors, due to higher or lower numbers of particles moving between storage and gate regions than intended, appear to substantially cancel one another out when the cells are viewed by a viewer.

Advantageously, the display device may comprise multiple pairs of first and second cells arranged in an array of rows and columns. For example, a typical display may comprise hundreds, or even thousands of pairs of cells. The cells may be controlled by row and column address electrodes that are driven by the drive circuitry.

Furthermore, the display may be an electrophoretic display, such as an in-plane electrophoretic display for enabling transmissive, reflective, or transflective display operation.

According to a third aspect of the invention, there is provided electronic drive circuitry, configured to drive the address electrodes of the display device of the second aspect of the invention so as to:

set the first cell of the pair to a storage mode by electrically attracting the first cell's charged particles to the first cell's storage region;

set the second cell of the pair to a gate mode by electrically attracting the second cell's charged particles to the second cell's gate region;

set the first cell from the storage mode to a target optical state by electrically attracting a display number of the first cell's charged particles from the first cell's storage region to the first cell's gate region, and then from the first cell's gate region to the first cell's display region; and

set the second cell from the gate mode to a target optical state by electrically attracting a surplus number of the second cell's charged particles from the second cell's gate region to the second cell's storage region, leaving a display number of the second cell's charged particles in the second cell's gate region, and then electrically attracting the second cell's display number of particles from the second cell's gate region to the second cell's display region.

In the context of this document, it is to be understood that the first and second cells of the or each pair are referred to as first and second cells simply because of the different drive methods that are used to drive them. It may be possible for a first cell to effectively become a second cell, simply by driving the first cell as though it were a second cell. The physical structures of the first and second cells may be identical, or they may be different, for example due to having different address electrode connections.

Further features of the invention will become apparent from the following non-limiting examples, and with reference to the accompanying drawings, in which:

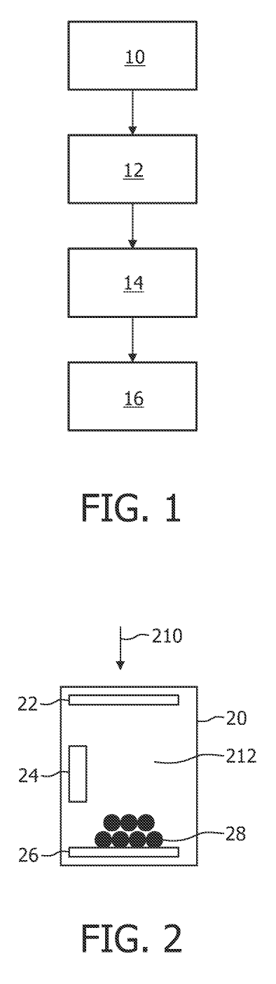

FIG. 1 shows a flow diagram of a method for driving a display device according to an embodiment of the invention;

FIG. 2 shows a diagram of an electrophoretic cell suitable for use in the method of FIG. 1;

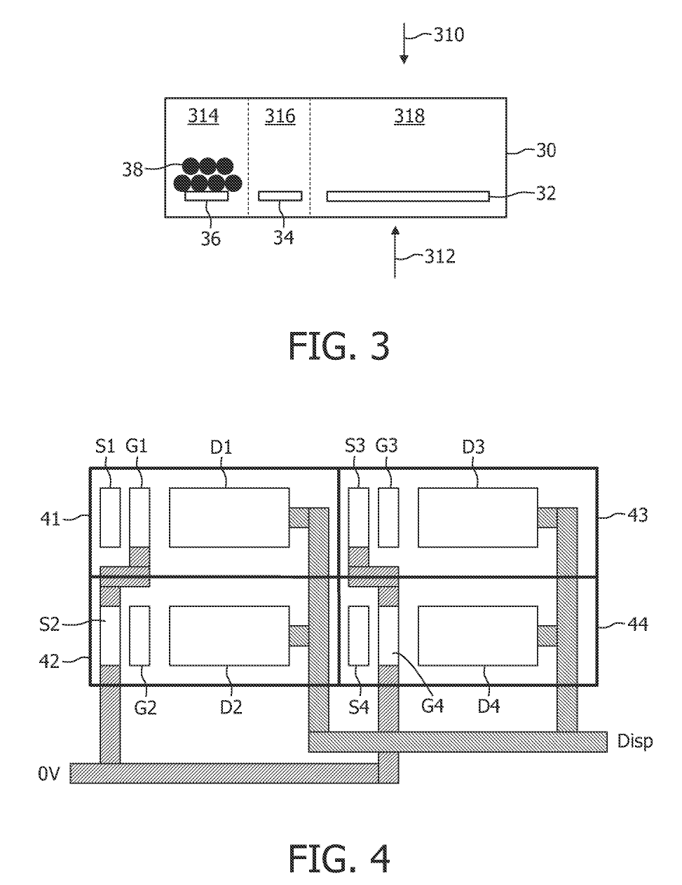

FIG. 3 shows a diagram of an in-plane electrophoretic cell suitable for use in the method of FIG. 1;

FIG. 4 shows a plan diagram of two pairs of the electrophoretic cells of FIG. 3, suitable for use in the method of FIG. 1;

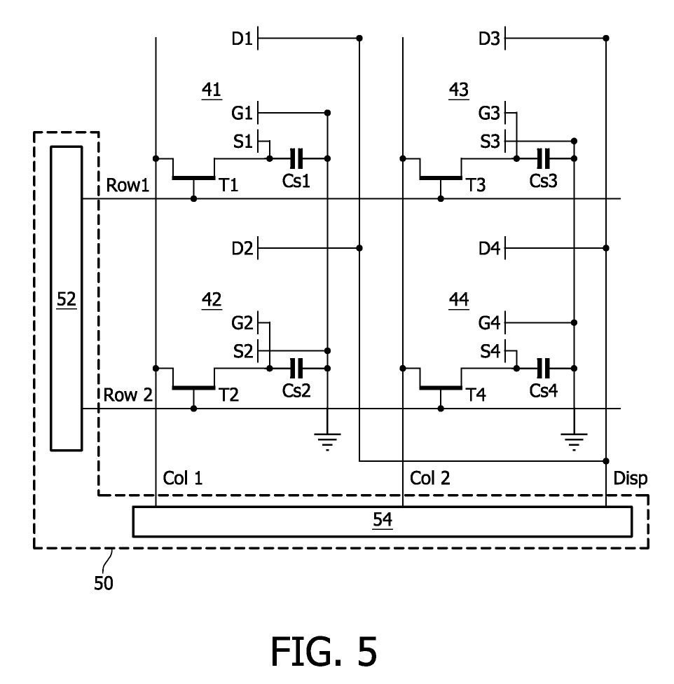

FIG. 5 shows a circuit diagram of a display device according to an embodiment of the invention that incorporates the two pairs of electrophoretic cells of FIG. 4; and

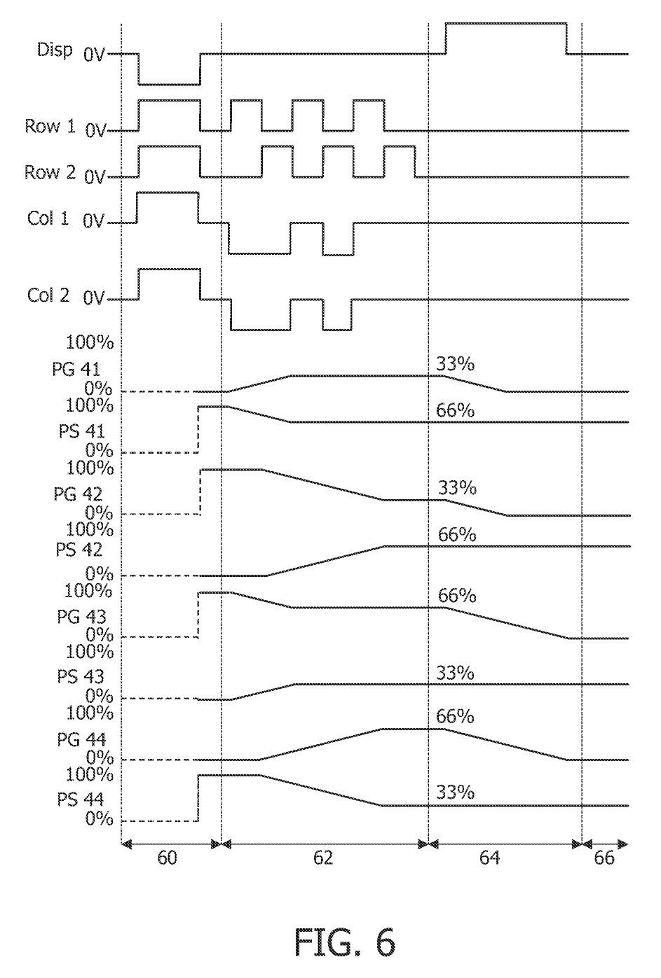

FIG. 6 shows a timing diagram according to an embodiment of the invention for driving the display device of FIG. 5.

The same reference numerals are used throughout the figures in order to indicate the same or similar features. The figures are not drawn to scale, and hence no attempts to derive relative dimensions/time periods from them are intended to be made.

FIG. 1 shows a flow diagram of a method for driving a moving particle display device according to an embodiment of the invention. The moving particle display device typically has hundreds or thousands of moving particle cells, each of which form a first or second cell of a pair. Each cell comprises movable charged particles, and has a storage region into which at least some of the movable charged particles may be moved, a gate region into which at least some of the movable charged particles may be moved, and a display region into which at least some of the movable charged particles may be moved.

A cell's display region is the region of the cell that determines the cell's optical state. The optical state is determined by the number of (movable charged) particles that are within the cell's display region. The cell's gate region is a region of the cell from which particles are moved into the display region. The cell's storage region is a region where the cell's particles can be temporarily stored, and is typically used to store excess particles that are not needed in the display region.

At step 10, the first cell of a pair is set to a storage mode by electrically attracting substantially all of the cell's particles to the cell's storage region. The term storage mode is used throughout this document to denote a cell that has substantially all of its particles in its storage region.

At step 12, the second cell is set to a gate mode by attracting substantially all of the cell's particles to the cell's gate region. The term gate mode is used throughout this document to denote a cell that has substantially all of its particles in its gate region.

At step 14, a display number of particles is attracted from the first cell's storage region to the cell's gate region, and then from the gate region to the display region, thereby setting the cell to a target optical state. The display number of a cell's particles is the number/proportion of the cell's particles that are transferred into the cell's display region in order to set the cell's optical state.

At step 16, a surplus number of particles is attracted from the second cell's gate region to the cell's storage region, leaving a display number of particles in the cell's gate region. Then the display number of particles in the gate region is attracted to the display region, thereby setting the cell to a target optical state. The surplus number of a cell's particles is the number or proportion of the cell's particles that must be moved from the cell's gate region to the cell's storage region, in order to leave a display number of particles in the cell's gate region.

In other embodiments, these method steps may take place in different orders or coincident with one another. For example, in a further embodiment, the first cell is set to the storage mode at the same time as the second cell is set to the gate mode. Then the first cell's display number of particles are moved to the cell's gate region, then the second cell's surplus number of particles are moved to the cell's storage region, and then the display number of particles in each cell's gate region are simultaneously moved to each cell's display region.

FIG. 2 shows a diagram of an electrophoretic cell 20 suitable for use in the method of FIG. 1. The diagram shows a cross-sectional view of a single cell 20 that is filled with an opaque white fluid 212 and with movable black charged particles 28. To control the movements of the particles 28, the cell 20 has cell electrodes comprising a transparent display electrode 22, a gate electrode 24, and a storage electrode 26. The cell is viewed from direction 210, and so the cell's current optical state is white since all the black particles are down in the region of the storage electrode 26 and are obscured from view by the opaque white fluid 212.

If cell 20 were to be driven as a first cell, then a display number of the black particles 28 would be attracted up to the region of the gate electrode 24, and then up to the transparent display electrode 22, giving the cell an optical state of black or of a shade of grey when viewed from direction 210.

If the cell were to be driven as a second cell, then firstly all the particles 28 would be attracted to the region of the gate electrode 24, setting the cell in the gate mode. Then a surplus number of the particles 28 would be attracted down to the region of the storage electrode 26, leaving a display number of the particles 28 in the region of the gate electrode 24. Then the display number of particles 28 would be attracted up to the transparent display electrode 22, giving the cell an optical state of black or of a shade of grey when viewed from direction 210.

Whether the cell appears to be black or a shade of grey clearly depends on the number of particles that are moved to the display electrode 22. Hence the larger the display number of particles, the closer to black the cell's optical state will be.

In other embodiments, the fluid and particle colors may be different to those described above, in order to give different colored optical states.

FIG. 3 shows a diagram of an in-plane electrophoretic cell suitable for use in the method of FIG. 1. The in-plane electrophoretic cell 30 is shown in cross-section, and is filled with a transparent fluid and with movable black charged particles 38. The cell 30 has cell electrodes comprising a transparent display electrode 32, a gate electrode 34, and a storage electrode 36. For ease of understanding, two dashed lines are superimposed on the diagram to roughly indicate where the divisions between the storage region 314, gate region 316, and display region 318 would lie. A light source 312 is positioned beneath the display region 318, such that the cell operates transmissively. The cell is currently in a storage mode, since all of the particles 28 are in the cell's storage region 314. Hence the cell has a transparent optical state since none of the black particles are in the display region 318, and so white light from light source 312 is seen when the cell is viewed from direction 310.

If cell 30 were to be driven as a first cell, then a display number of the black particles 38 would be attracted from the region 314 of the storage electrode and to the region 316 of the gate electrode 34, and then to the region 318 of the transparent display electrode 32, where the display number of particles would obscure the light from light source 312, making the cell look black or a shade of grey when viewed from direction 310.

If the cell were to be driven as a second cell, then firstly all the particles 38 would be attracted to the region 316 of the gate electrode 34, setting the cell to the gate mode. Then a surplus number of the particles 38 would be attracted to the region 314 of the storage electrode 36, leaving a display number of the particles 38 in the region 316 of the gate electrode 34. Then the display number of particles 38 would be attracted to the region 318 of the transparent display electrode 32, where they would obscure the light from light source 312, making the cell look black or a shade of grey when viewed from direction 310.

Whether the cell appears to be black or a shade of grey clearly depends on the number of particles that are moved to the region of the display electrode 32. The higher the display number of particles, the more the white light from light source 312 will be obscured, and the closer the cell will appear to black when viewed from direction 310.

In other embodiments, the colors of the light source 312 and the particles 38 may be different to those described above. For example, in an embodiment comprising six cells that are treated as three pairs of cells, the first pair of cells have red light sources beneath them, the second pair of cells have green light sources beneath them, and the third pair of cells have blue light sources beneath them. The particles of all six cells are colored black, and hence the six cells together constitute a single RGB color pixel.

The in-plane electrophoretic cell of FIG. 3 may be modified by replacing the light source 312 with a reflecting surface, e.g. a white surface placed below the transparent conductor 32, to give reflective instead of transmissive operation. Then, when no black particles are in the display region, the cell will appear white, and when multiple black particles are in the display region, the cell will appear black or a shade of grey.

FIG. 4 shows a plan diagram of two pairs of the electrophoretic cells of FIG. 3, suitable for use in the method of FIG. 1. For simplicity, these cells are reflective cells that appear white when the cell has a transparent optical state, and that appear black or a shade of grey when the cell has a respective optical state of black or a shade of grey. The reflector, not shown on FIG. 4 for clarity, is placed beneath the transparent display electrodes D1-D4. In other embodiments, the display electrodes themselves may be reflective rather than transparent, to reduce the need for a separate reflector.

In the diagram of FIG. 4, cells 41 and 42 form one pair of cells, and cells 43 and 44 form another pair of cells. Each cell has cell electrodes comprising a storage electrode (S1-S4), a gate electrode (G1-G4), and a display electrode (D1-D4). The cell electrodes D1-D4 are all connected to an address electrode (Disp).

The movable particles within each cell are negatively charged, and therefore move towards higher, positive, electric potentials, i.e. in the opposite direction to applied electric fields. For example, the address electrode Disp may be driven to a high electric potential to move (attract) particles from each cell's gate region to each cell's display region.

The cell electrodes G1, S2, S3, and G4 are all connected to 0V. The cell electrodes S1, G2, G3, S4 are each controlled separately, using an active matrix comprising active switching circuitry and row and column address electrodes. The active matrix is not shown on FIG. 4 for clarity, but is shown on FIG. 5 and described in detail further below. The cells 41 and 44 are driven as first cells that are set to the storage mode by applying positive voltages to S1 and S4, thereby attracting the cells' particles to S1 and S4. The cells 42 and 43 are driven as second cells that are set to the gate mode by applying positive voltages to G2 and G3, thereby attracting the cells' particles to G2 and G3. Additionally, when setting the cells to storage or gate modes, the address electrode Disp is driven to a negative voltage, thereby attracting particles from the cells' display regions to the cells' gate regions.

In the diagram of FIG. 4, the first and second cells of each pair are shown as being immediately adjacent to one another. Alternatively, the first and second cells of a pair may be spaced apart from each other by other cells. In this case the first and second cells are still considered as being adjacent to one another, as light from the first and second cells will still appear to merge together when the cells are viewed from a distance, such that errors in the cell's optical states will still appear to compensate one another.

FIG. 5 shows a circuit diagram of a display device according to an embodiment of the invention that incorporates the two pairs of electrophoretic cells of FIG. 4. The circuit diagram shows electronic drive circuitry 50 and address electrodes Row 1, Row 2, Col 1, and Col 2 that are used to control the electric potentials applied to the S1, G2, G3, and S4 cell electrodes. The electronic drive circuitry 50 comprises row driver 52 for driving address electrodes Row 1 and Row 2, and column driver 54 for driving address electrodes Col 1, Col 2, and Disp.

Thin Film Transistors (TFTs) T1-T4 are used as active switches that are controlled by the Row 1 and Row 2 address electrodes to selectively apply the voltages on the Col 1 and Col 2 address electrodes to the cell electrodes S1, G2, G3 and S4. Capacitors Cs1-Cs4 are used to help maintain the applied column voltages on the cell electrodes S1, G2, G3, and S4, even after the corresponding TFTs have been switched off. In a further embodiment (not shown), addressing electrodes do not control active switching circuitry for controlling S1, G2, G3, and S4, and so form part of a passive matrix. For example, in a passive matrix, the cell electrodes may be connected directly to the address electrodes, as will be apparent to those skilled in the art.

The drive circuitry 50 may be an arrangement of TFTs on the display substrate, a Field Programmable Gate Array (FPGA), an application-specific integrated circuit (ASIC), or any other circuit configured to generate drive signals for driving the address electrodes in the specified manner, as will be apparent to those skilled in the art.

FIG. 6 shows a timing diagram according to an embodiment of the invention for driving the display device of FIG. 5. The timing diagram shows the voltage waveforms that are applied to the Disp, Row 1, Row 2, Col 1, and Col 2 address electrodes, and also shows the resulting particle distributions between each cell's storage and gate regions. Traces PG 41-44 indicate the number of particles in the gate region of respective cells 41-44, and traces PS 41-44 indicate the number of particles in the storage region of respective cells 41-44. For example, at the beginning of time period 64, trace PG 41 shows that 33% of the particles of cell 41 are within the gate region of cell 41, and trace PS 41 shows that 66% of the particles of cell 41 are within the storage region of cell 41. At the end of time period 64, the number of particles in the gate region PG 41 has fallen to 0%, while the number of particles in the storage region PS 41 has remained at 66%, indicating that 33% of the display particles have moved to the display region of cell 41.

The timing diagram shows the rows and columns being driven to drive the first pair of cells 41 and 42 to a target optical state of a grey level of 33% (i.e. 33% of the way from transparent to black, by moving 33% of the cell's moving black particles into the cell's display region), and to drive the second pair of cells 43 and 44 to a target optical state of a grey level of 66% (i.e. 66% of the way from transparent to black, by moving 66% of the cell's black particles into the cell's display region).

Firstly, during time period 60, all of the first cells (41, 44) are set to the storage mode and all of the second cells (42, 43) are set to the gate mode. To do this, the Disp electrode is set to a negative voltage, and for each cell one of the cell's storage or gate electrodes is set to a positive voltage. Therefore, each cell's negatively charged particles move to the electrode of the cell that is set to the positive voltage. For example, at the end of time period 60, the PS 41 trace shows that 100% of the cell 41 particles are within the cell 41 storage region, i.e. that cell 41 is in the storage mode.

Next, during time period 62, the columns Col 1 and Col 2 are driven with voltages to be placed on the electrodes S1, G2, G3, and S4, and the rows Row 1 and Row 2 are driven with pulses to turn on each cell's TFT at the appropriate times. For example, cell 41 has electrodes S1, G1, D1, the gate electrode G1 being connected to 0V, and the storage electrode S1 being controlled by Row 1 and Col 1. When Row 1 is pulsed high for the first time, T1 connects the electrode S1 to the negative Col 1 voltage, setting S1 at a lower electric potential than G1, and causing particles to move from the storage region PS 41 to the gate region PG 41, as shown on FIG. 6. The negative column voltage is held on the storage electrode S1, even after the Row 1 voltage falls and turns T1 off, due to the capacitor Cs1. Then when Row 1 is pulsed high for the second time, T1 connects the electrode S1 to the 0V Col 1 voltage, setting S1 at the same voltage as G1, and therefore halting further particle movements.

In the case of cell 43, both first and second Row 1 pulses cause a negative potential to be applied to electrode G3, and so particle movements continue for a longer period of time, resulting in a higher number of particles being moved between the gate and storage regions. Hence the number of particles that are moved between each cell's gate and storage region (and hence the cell's optical state) can be controlled by the number of row pulses for which a negative voltage is applied to their gate or storage electrode.

At the end of time period 62, cells 41 and 42 have 33% of their particles in their gate regions, and cells 43 and 44 have 66% of their particles in their gate regions. Cells 41 and 44 are first cells and hence reach this state by being set to the storage mode, and then having a display number of their particles moved from their storage region to their gate region. Cells 42 and 43 are second cells and hence reach this state by being set to the gate mode, and then having a surplus number of their particles moved from their gate region to their storage region.

During time period 64, the electrode Disp is driven high, attracting the particles in each cell's gate region to the cell's display region. The number of particles in each cell's storage region remains the same since there is no significant electric field between the gate and storage electrodes. By the end of time period 64, each cell's display number of particles have been moved into the cell's display region, thereby setting each cell to its target optical state.

If the particles of all cells were to move more slowly than anticipated, for example due to a decrease in temperature, a decrease in the magnitude of the column voltages, or a negative offset in the 0V potential, then the gradients of the traces PG 41-PS 44 during time period 62 would reduce. This would cause less than 33% of the cell 41 particles to be moved into the cell 41 display region, and more than 33% of the cell 42 particles to be moved into the cell 42 display region. Therefore, cell 41 would have an optical state further from black than intended, and cell 42 would have an optical state closer to black than intended. Then when the cells 41 and 42 were viewed from a distance, the light from each of them would appear to merge, and so they would together appear as though they both had the correct optical state, i.e. a grey level of 33%. Hence the errors due to the slow particle movements effectively cancel one another out.

In the above, a system for driving a moving particle display device, such as an electrophoretic display device, is described. The display device comprises first and second cells that are set to target optical states to give the cells' their target optical appearances. The first and second cells are driven differently from one another, such that errors in the first cell's target optical state occur in the opposite direction to errors in the second cell's target optical state. Hence, when the cells are viewed from a distance by a viewer of the display, the light from the first and second cells mixes together, and the optical state errors appear to compensate or cancel one another out.

There are many other variations on the cell arrangements and drive schemes described herein that also fall within the scope of the appended claims, as will be apparent to those skilled in the art.

1. A method for driving a display device, the display device comprising at least one pair of first and second cells (41, 42), the first and second cells of the pair being positioned adjacent to one another, each cell (30) comprising:
movable charged particles (38);
a storage region into which at least some of the charged particles may be moved (314);
a gate region into which at least some of the charged particles may be moved (316);
a display region into which at least some of the charged particles may be moved (318); the number of charged particles in the display region determining an optical state of the cell; and
the method comprising:
setting (10) the first cell of the pair to a storage mode by electrically attracting the first cell's charged particles to the first cell's storage region;
setting (12) the second cell of the pair to a gate mode by electrically attracting the second cell's charged particles to the second cell's gate region;
setting (14) the first cell from the storage mode to a target optical state by electrically attracting a display number of the first cell's charged particles from the first cell's storage region to the first cell's gate region, and then from the first cell's gate region to the first cell's display region; and
setting (16) the second cell from the gate mode to a target optical state by electrically attracting a surplus number of the second cell's charged particles from the second cell's gate region to the second cell's storage region, leaving a display number of the second cell's charged particles in the second cell's gate region, and then electrically attracting the second cell's display number of particles from the second cell's gate region to the second cell's display region.

2. The method of claim 1, comprising performing the method steps in such an order that the first and second cells are set to their target optical states for at least partially overlapping time periods.

3. The method of claim 1, further comprising repeating the method steps of claim 1, with the first cell driven as though it were the second cell, and with the second cell driven as though it were the first cell.

4. The method of claim 1, wherein each cell further comprises a storage electrode (36) associated with the cell's storage region, and a gate electrode (34) associated with the cell's gate region, and wherein:
the electrical attraction of the display number of the first cell's charged particles from the first cell's storage region to the first cell's gate region comprises applying drive signals to at least one of the first cell's storage and gate electrodes, the drive signals sufficient to attract charged particles from the first cell's storage region to the first cell's gate region; and
the electrical attraction of the surplus number of the second cell's charged particles from the second cell's gate region to the second cell's storage region comprises applying drive signals to at least one of the second cell's storage and gate electrodes, the drive signals sufficient to attract charged particles from the second cell's count region to the second cell's reservoir region.

5. The method of claim 4, wherein:
the drive signals applied to at least one of the first cell's storage and gate electrodes are applied for a length of time sufficient to attract the display number of the first cell's charged particles to the first cell's gate region; and
the drive signals applied to at least one of the second cell's storage and gate electrodes are applied for a length of time sufficient to attract the surplus number of the second cell's charged particles to the second cell's storage region.

6. The method of claim 1, wherein each cell further comprises a display electrode (32) associated with the cell's display region, and wherein:
the electrical attraction of the display number of the first cell's charged particles from the first cell's gate region to the first cell's display region comprises applying drive signals to at least one of the first cell's gate and display electrodes, the drive signals sufficient to attract charged particles from the first cell's gate region to the first cell's display region; and
the electrical attraction of the display number of the second cell's charged particles from the second cell's gate region to the second cell's display region comprises applying drive signals to at least one of the second cell's gate and display electrodes, the drive signals sufficient to attract charged particles from the second cell's gate region to the second cell's display region.

7. The method of claim 6, wherein:
the drive signals applied to at least one of the first cell's gate and display electrodes are applied for a length of time sufficient to attract the display number of the first cell's charged particles to the first cell's display region; and
the drive signals applied to at least one of the second cell's gate and display electrodes are applied for a length of time sufficient to attract the display number of the second cell's charged particles to the second cell's display region.

8. The method of claim 1, wherein the display device comprises multiple pairs of cells (41, 42, 43, 44) arranged in an array of rows and columns, and wherein the cells forming even numbered rows are driven as first cells, and wherein the cells forming odd numbered rows are driven as second cells.

9. The method of claim 1, wherein the display device comprises multiple pairs of cells (41, 42, 43, 44) arranged in an array of rows and columns, and wherein the cells along each row alternate between cells that are driven as first cells and second cells, and wherein the cells along each column alternate between cells that are driven as first cells and second cells.

10. A display device comprising at least one pair of first and second cells (41, 42), the first and second cells of the pair being positioned adjacent to one another, each cell (30) comprising:
movable charged particles (38);
a storage region (314) into which at least some of the charged particles may be moved;
a gate region (316) into which at least some of the charged particles may be moved;
a display region (318) into which at least some of the charged particles may be moved; the number of charged particles in the display region determining an optical state of the cell; and
the display device further comprising address electrodes (row 1, row 2, Col 1, Col 2, disp) and electronic drive circuitry (50), the drive circuitry being configured to drive the address electrodes so as to:
set the first cell of the pair to a storage mode by electrically attracting the first cell's charged particles to the first cell's storage region;
set the second cell of the pair to a gate mode by electrically attracting the second cell's charged particles to the second cell's gate region;
set the first cell from the storage mode to a target optical state by electrically attracting a display number of the first cell's charged particles from the first cell's storage region to the first cell's gate region, and then from the first cell's gate region to the first cell's display region; and
set the second cell from the gate mode to a target optical state by electrically attracting a surplus number of the second cell's charged particles from the second cell's gate region to the second cell's storage region, leaving a display number of the second cell's charged particles in the second cell's gate region, and then electrically attracting the second cell's display number of particles from the second cell's gate region to the second cell's display region.

11. The display device of claim 10, wherein each cell (30) has cell electrodes comprising:
a storage electrode (36) associated with the cell's storage region for electrically attracting charged particles to the cell's storage region;
a gate electrode (34) associated with the cell's gate region for electrically attracting charged particles to the cell's gate region; and
a display electrode (32) associated with the cell's display region, for electrically attracting charged particles to the cell's display region.

12. The display device of claim 10, wherein the display device is an electrophoretic display.

13. The display of claim 12, wherein the electrophoretic cells are in-plane electrophoretic cells.

14. The display device of claim 10, wherein the display device comprises multiple pairs of first and second cells (41, 42, 43, 44) arranged in an array of rows and columns.

15. The display device of claim 14, wherein the first cells form even numbered rows, and wherein the second cells form odd numbered rows, and wherein the drive circuitry is configured to drive the address electrodes to:
set the first cells to one of the storage and gate modes;
set the second cells to the other of the storage and gate modes; and
set the first and second cells from the storage and gate modes to target optical states.

16. The display device of claim 14, wherein the cells along each row alternate between first cells (41, 44) and second cells (42, 43), and wherein the cells along each column alternate between first cells (41, 44) and second cells (42, 43), and wherein the drive circuitry is configured to drive the address electrodes to:
set the first cells to one of the storage and gate modes;
set the second cells to the other of the storage and gate modes; and
set the first and second cells from the storage and gate modes to target optical states.

17. Electronic drive circuitry, configured to drive the address electrodes (Row 1, Row 2, Col 1, Col 2, Disp) of so as to:
set the first cell (41) of the pair to a storage mode by electrically attracting the first cell's charged particles (38) to the first cell's storage region (314);
set the second cell (42) of the pair to a gate mode by electrically attracting the second cell's charged particles (38) to the second cell's gate region (316);
set the first cell from the storage mode to a target optical state by electrically attracting a display number of the first cell's charged particles from the first cell's storage region to the first cell's gate region, and then from the first cell's gate region to the first cell's display region 318); and
set the second cell from the gate mode to a target optical state by electrically attracting a surplus number of the second cell's charged particles from the second cell's gate region to the second cell's storage region, leaving a display number of the second cell's charged particles in the second cell's gate region, and then electrically attracting the second cell's display number of particles from the second cell's gate region to the second cell's display region (318).
